(19) United States
(12) Patent Application Publication
(10) Pub. No.: US 2010/0322769 A1
(43) Pub. Date: Dec. 23, 2010

(54) FLUID TURBINE OPTIMIZED FOR POWER GENERATION

(76) Inventors: Thomas Glenn Stephens, Grand Prairie, TX (US); Brandon D. Brantley, JR., Fort Worth, TX (US); Jason Daniel Cormey, Dallas, TX (US); Robert Clifton Vance, Arlington, TX (US); Peter Chris Skarzenski, Dallas, TX (US)

Correspondence Address: KENNETH T. EMANUELSON;The Danamraj Law Group, P.C., 5910 N. CENTRAL EXPRESSWAY, Suite 1450, DALLAS, TX, 75206, US

(21) Appl. No.: 12/614,232

(22) Filed: Nov. 6, 2009

Related U.S. Application Data
(63) Continuation-in-part of application No. 12/110,100, filed on Apr. 25, 2008.
(60) Provisional application No. 61/031,317, filed on Feb. 25, 2008.

(51) Int. Cl. F03D 3/06

(52) U.S. Cl. 416/119

(57) ABSTRACT

A fluid turbine comprising a rotor, having an axis of rotation, comprising at least two rotor blades disposed at a radius from the axis of rotation, each rotor blade having a pitch axis and a variable pitch angle. The fluid turbine comprises a mechanism operable to control the pitch angle of at least one rotor blade about its pitch axis and to vary the pitch angle of the rotor blade between various pitch angles as the blade moves radially about the axis of rotation of the rotor.

### SUMMARY OF THE INVENTION

According to a first embodiment, the present disclosure relates to a fluid turbine comprising a rotor, having an axis of rotation, comprising at least two rotor blades disposed at a radius from the axis of rotation, each rotor blade having a pitch axis and a variable pitch angle. The fluid turbine further comprises a mechanism operable to control the pitch angle of at least one rotor blade about its pitch axis and to vary the pitch angle of the rotor blade from a first pitch angle at a first radial location about the axis of rotation to a second pitch angle at a second radial location about the axis of rotation.

According to a second embodiment, the present disclosure relates to a fluid turbine comprising a rotor, having an axis of rotation, comprising at least two rotor blades disposed at a radius from the axis of rotation, each rotor blade having a pitch axis and a variable pitch angle. The fluid turbine further comprises a mechanism operable to control the pitch angle of at least one rotor blade about its pitch axis and to vary the pitch angle of the rotor blade from a first pitch angle at a first radial location about the axis of rotation to a second pitch angle at a second radial location about the axis of rotation to a third pitch angle at a third radial location about the axis of rotation.

According to a third embodiment, the present disclosure relates to a fluid turbine comprising a rotor, having an axis of rotation, comprising at least two rotor blades disposed at a radius from the axis of rotation, each rotor blade having a pitch axis and a variable pitch angle. The fluid turbine further comprises a mechanism operable to control the pitch angle of at least one rotor blade about its pitch axis and to vary the pitch angle of the rotor blade from a first pitch angle at a first radial location about the axis of rotation to a second pitch angle at a second radial location about the axis of rotation to a third pitch angle at a third radial location about the axis of rotation to a fourth pitch angle at a fourth radial location about the axis of rotation.

### BRIEF DESCRIPTION OF THE DRAWINGS

FIG. 1 is an isometric view of a fluid turbine according to certain embodiments of the present disclosure;

FIG. 2 is an end view of a fluid turbine according to certain embodiments of the present disclosure;

FIG. 3 is an end view of a rotor blade according to certain embodiments of the present disclosure;

FIG. 4 is an end view of a rotor blade according to certain embodiments of the present disclosure;

FIG. 5 is a graph of three profiles of rotor blade pitch (theta) vs. rotor blade position (psi) about the central axis of rotation of the turbine;

FIG. 6 is a table showing, for each of the three profiles in FIG. 5, the rotor blade pitch (theta) at eight distinct blade positions about the central axis of rotation of the turbine;

FIG. 7 is a graph of two profiles of rotor blade pitch (theta) vs. rotor blade position (psi) about the central axis of rotation of the turbine;

FIG. 8 is a table showing, for each of the two profiles in FIG. 7, the rotor blade pitch (theta) at eight distinct blade positions about the central axis of rotation of the turbine;

FIG. 9 is an isometric view of a rotor hub according to one embodiment of the present invention;

FIG. 10 is a front view of a rocker assembly according to certain embodiments of the present invention; and

FIG. 11 is a top view of a rocker assembly according to certain embodiments of the present invention.

### DETAILED DESCRIPTION OF THE DRAWINGS

A system and method of the present patent application will now be described with reference to various examples of how the embodiments can best be made and used. Like reference numerals are used throughout the description and several views of the drawings to indicate like or corresponding parts, wherein the various elements are not necessarily drawn to scale.

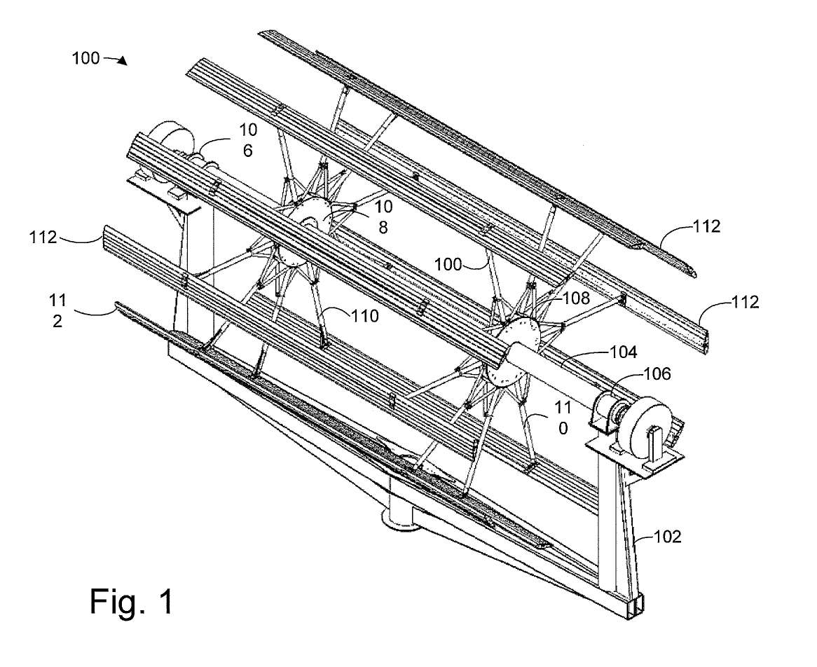

FIG. 1 is an isometric view of a fluid turbine 100 according to certain embodiments of the present disclosure. Structurally, turbine 100 consists of a rotor assembly comprising a torque tube 104 riding on bearings 106 mounted on a frame 102. Torque tube 102 is designed to prevent each rotor hub 108 from rotating independently of the other rotor hubs 108. Torque tube 104 is oriented along a central axis which is intended to be disposed generally perpendicular to the direction of fluid flow. The turbine 100 comprises arrays of radially-disposed struts 110 mounted to rotor hubs 108 at their proximal ends and to a set of rotor blades 112 at their distal ends. The rotor blades 112 shown in FIG. 1 are tapered airfoils/hydrofoils having a clearly defined leading and trailing edge. Turbine 100 shown in FIG. 1 comprises 10 blades, but alternate embodiments may have more or fewer blades, depending on the application. The rotor blades 112 are attached to the struts 110 in such a manner as to allow the rotor blades 112 to be individually pivoted with respect to the axis of rotation of turbine 100, thus altering the pitch angle of each rotor blade 112 with respect to the direction of fluid flow through turbine 100. The angle of the rotor blades may be controlled via mechanical linkages, hydraulics, pneumatics, linear or rotary electromechanical actuators, or any combination thereof. In certain embodiments, the rotor pitch angle profile may be controlled by a cam-and-follower mechanism operating in concert with one or more of the above systems of actuation, as set forth in further detail below.

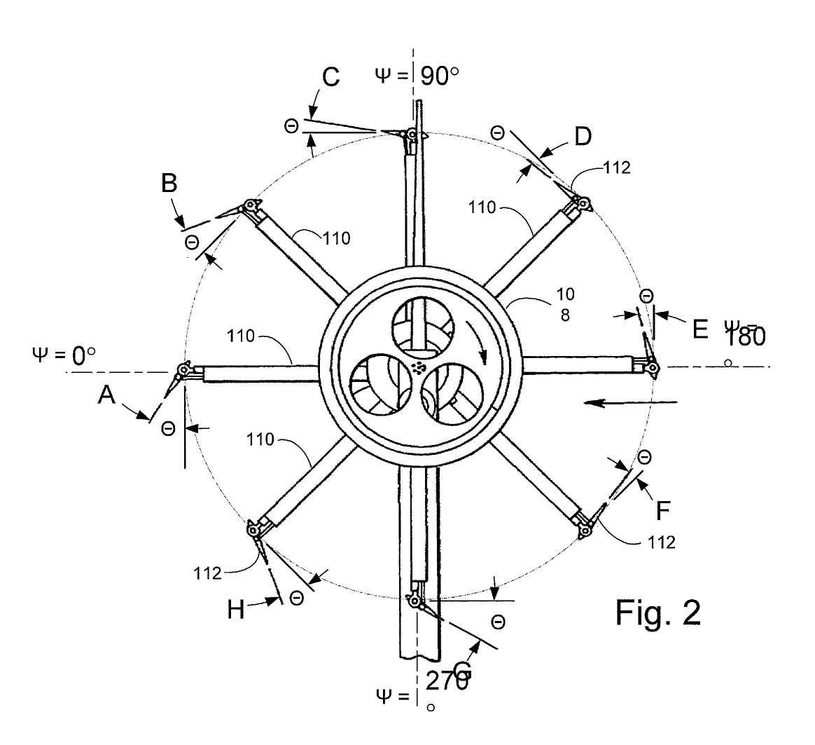

FIG. 2 is an end view of a fluid turbine 100 according to certain embodiments of the present disclosure. The fluid turbine 100 shown in FIG. 2 incorporates eight rotor blades 112. The pitch angle of the eight rotor blades 112 are designated angles A-H with the blade pitch angle of the rotor blade at angular position 0 being designated angle “A”. The blade pitch angles of the other rotor blades 112 are designated angles “B” through “H”, at multiples of 45 degrees from angle “A”, clockwise. Thus, angle “B” is the pitch angle of a rotor blade 112 disposed at an angular position 45 degrees clockwise from 0, angle “C” is the pitch angle of a rotor blade 112 disposed at an angular position 90 degrees from 0, and so forth.

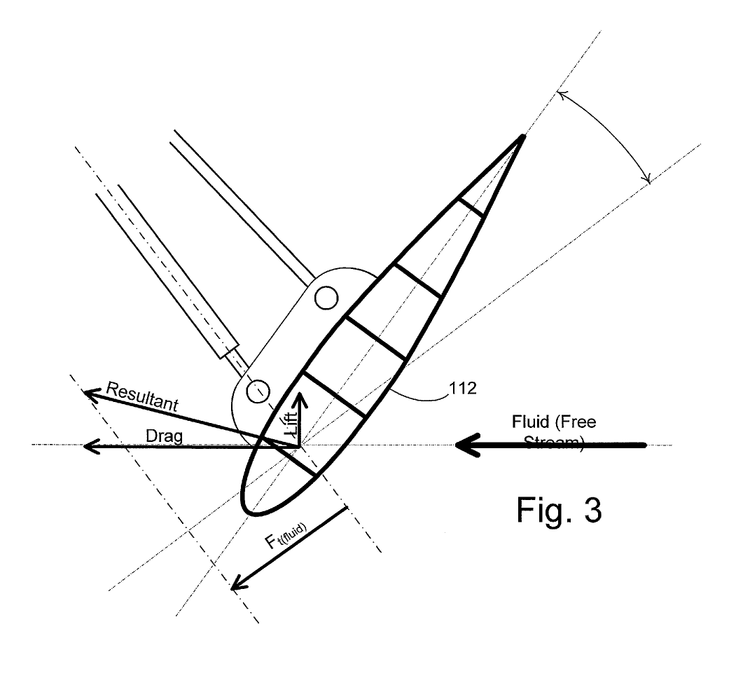

FIG. 3 is an end view of a rotor blade 112 according to certain embodiments of the present disclosure. FIG. 3 depicts the forces acting upon a rotor blade 112 owing to the effects of free stream fluid flow over the blade. It can be seen in this figure that a rotor blade 112 experiences both a DRAG force and a LIFT force as a result of the fluid flow over the rotor blade 112. The combined effect of the DRAG force and the LIFT force is represented by a RESULTANT vector. The component of the RESULTANT vector acting along a plane tangent to the radius about which the rotor blade 112 is moving is designated Ft(fluid). As can be seen in FIG. 3, Ft(fluid) acts in the same direction as the direction of rotation of the turbine 100, thus indicating that Ft(fluid) will tend to accelerate the rotational velocity of the turbine 100.

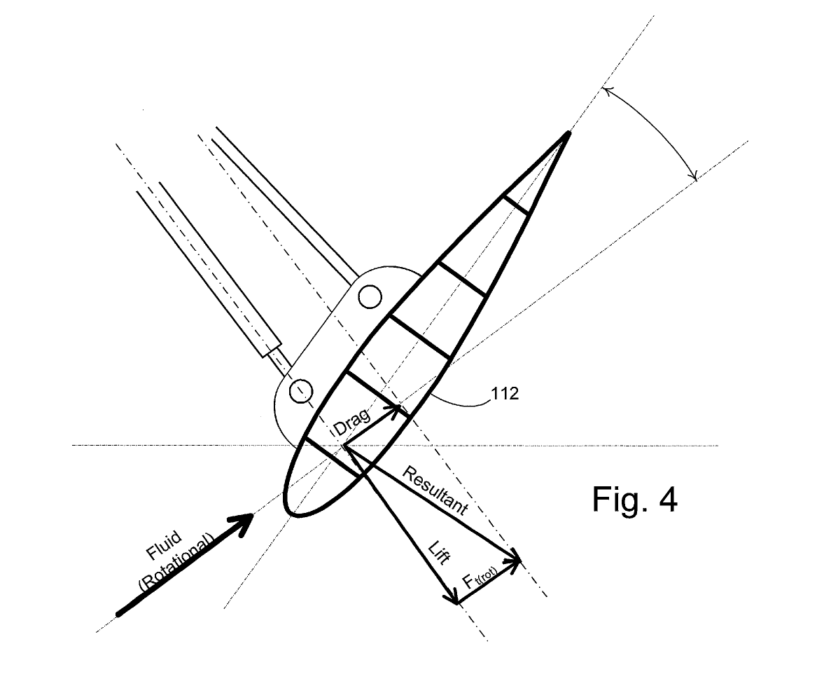

FIG. 4 is an end view of a rotor blade 112 according to certain embodiments of the present disclosure. FIG. 4 depicts the forces acting upon a rotor blade 112 owing to the dynamic effects of fluid flow over the rotor blade 112 as a result of rotation of the rotor blade 112 through the fluid stream. It can be seen in this figure that a rotor blade 112 experiences both a DRAG force and a LIFT force as a result of the fluid flow over the rotor blade 112. As with FIG. 3, the combined effect of the DRAG force and the LIFT force is represented by a RESULTANT vector. The component of the RESULTANT vector acting along a plane tangent to the radius about which the rotor blade 112 is moving is designated Ft(rot). As can be seen in FIG. 4, Ft(rot) acts in the opposite direction from the direction of rotation of the turbine 100, thus indicating that Ft(rot) will tend to decelerate the rotational velocity of the turbine 100.

The magnitude of the acceleration vector on the rotor blade 112 is the sum of the magnitude of Ft(fluid) and Ft(rot). If the sum of these two vectors is positive along the tangent vector, the aerodynamic forces acting on the rotor blade 112 at this position will tend to accelerate the turbine 100. If the sum of these two vectors is negative along the tangent vector, the aerodynamic forces acting on the rotor blade 112 at this position will tend to decelerate the turbine 100. The total acceleration torque acting on the turbine 100 at a given time is the sum of all the acceleration torques imparted by the individual rotor blades 112 at that time.

In general, it will be desirable to maximize the total torque imparted to the turbine 100 by the combined effects of rotation of the rotor blades 112 through the fluid stream and fluid movement through the rotor. Because of the fact that the angle between a rotor blade 112 and the fluid flow will vary as the rotor blade 112 moves around the axis of rotation of the turbine 100, the optimal pitch angle for torque generation will vary accordingly as that rotor blade 112 moves around the axis of rotation. In order to optimize the angle between the blade pitch and the fluid flow, the turbine 100 disclosed herein incorporates at least one mechanism to vary the blade pitch according to angular position as a rotor blade 112 moves around the rotational axis of the turbine 100. The pattern or profile of blade pitch vs. angular position may vary depending on a number of factors, including but not limited to rotor velocity and free stream fluid velocity. Thus, it may be desirable to modify the blade pitch profile as conditions change.

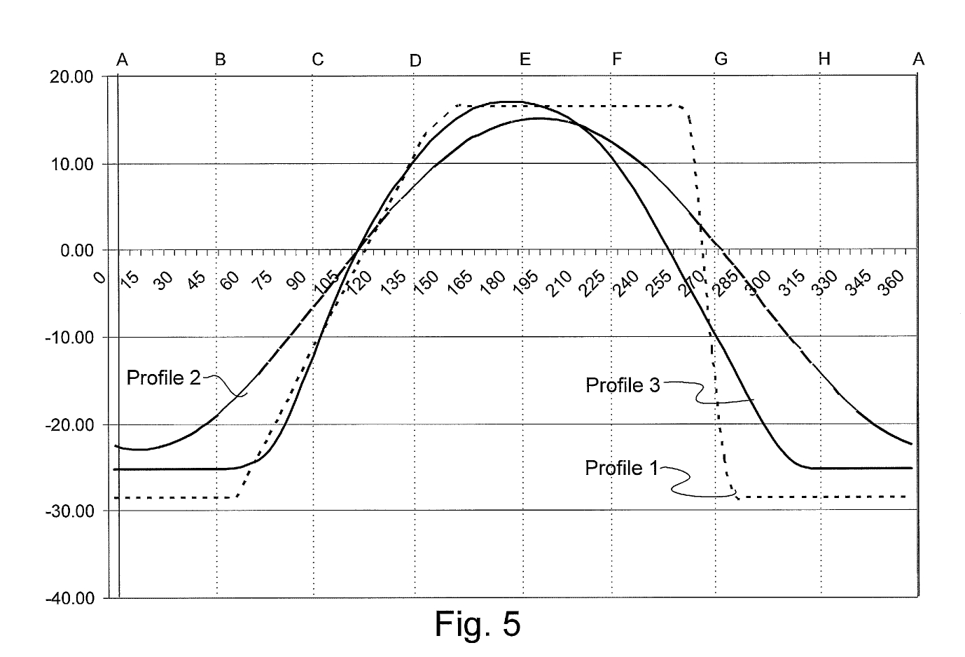

FIG. 5 is a graph of three separate profiles of rotor blade pitch (theta) vs. rotor blade position (psi) about the central axis of rotation of the turbine. The profiles are designated “Profile 1,” “Profile 2” and “Profile 3.” It can be seen from FIG. 5 that Profile 2 has the shape of a sinusoid. This is the type of profile that is generated from an offset circular cam. Profiles 1 and 3 are non-sinusoidal profiles, although each incorporates certain sinusoidal attributes. Angular positions A-H about the axis of rotation of the rotor are designated by the appropriate letters. Those of skill in the art will recognize that a blade pitch value of zero represents the condition wherein the blade is aligned tangent to the radius along which the blade moves. This alignment may also be described as one lying normal to a vector from the axis of rotation of the rotor to the pitch axis of the rotor blade. A positive pitch angle value represents the condition wherein the nose of the blade is disposed out away from the axis of rotation of the turbine and a negative pitch angle value represents the condition wherein the nose of the blade is disposed in toward the axis of rotation of the rotor.

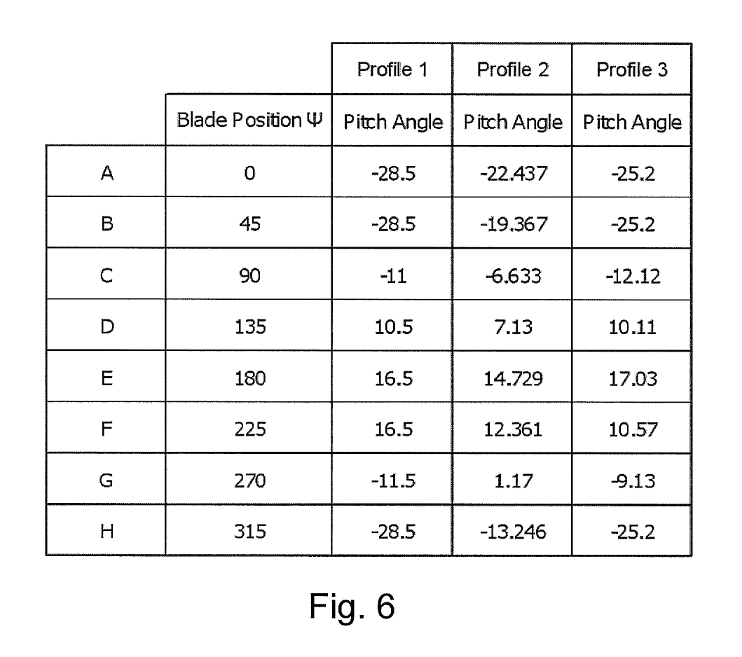

FIG. 6 is a table showing the rotor blade pitch (theta) at eight distinct blade positions A-H about the central axis of rotation of the turbine 100. Angular positions A-H set forth in FIG. 6 correspond to the positions shown in FIG. 2. Those of skill in the art will appreciate that the pitch angles set forth in FIG. 6 are certain specific angles which have been shown to be useful within the context of the present disclosure. Those of skill in the art will also appreciate that profiles similar to those shown and described will be useful within the context of the present disclosure.

As described above, those of skill in the art will recognize that a blade pitch value of zero in FIG. 6 represents the condition wherein the blade is aligned tangent to the radius along which the blade moves, while a positive value represents the condition wherein the nose of the blade is disposed out away from the axis of rotation of the turbine and a negative value represents the condition wherein the nose of the blade is disposed in toward the axis of rotation of the turbine.

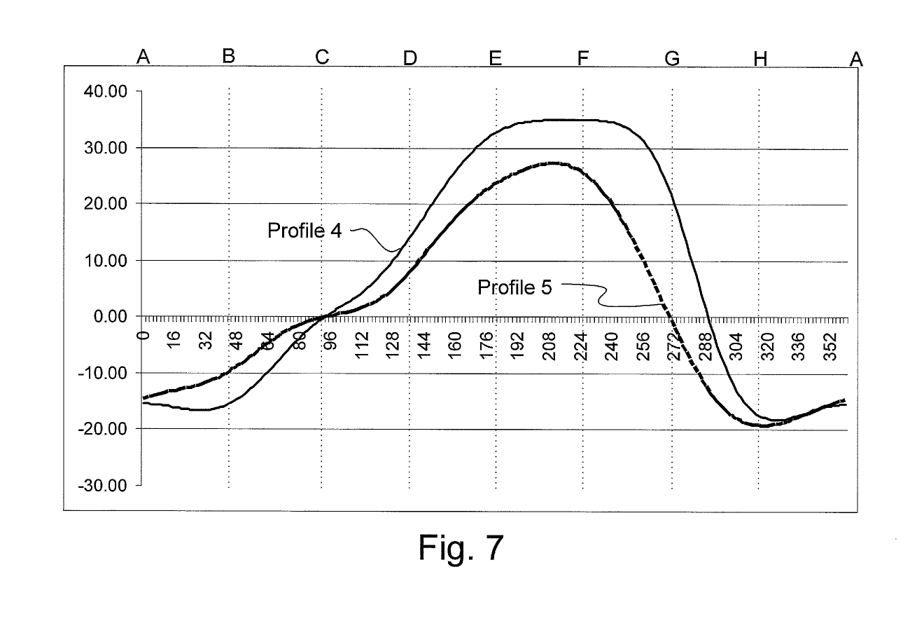

FIG. 7 is a graph of two profiles of rotor blade pitch (theta) vs. rotor blade position (psi) about the central axis of rotation of the rotor. The profiles are designated “Profile 4” and “Profile 5.” Profiles 4 and 5 are non-sinusoidal profiles, although each incorporates certain sinusoidal attributes. Angular positions A-H about the axis of rotation of the rotor are designated by the appropriate letters and correspond to the positions shown in FIG. 2. Those of skill in the art will recognize that a blade pitch value of zero represents the condition wherein the blade is aligned tangent to the radius along which the blade moves. This alignment may also be described as one lying normal to a vector from the axis of rotation of the rotor to the pitch axis of the rotor blade. As above, a positive value represents the condition wherein the nose of the blade is disposed out away from the axis of rotation of the turbine, while a negative value represents the condition wherein the nose of the blade is disposed in toward the axis of rotation of the turbine.

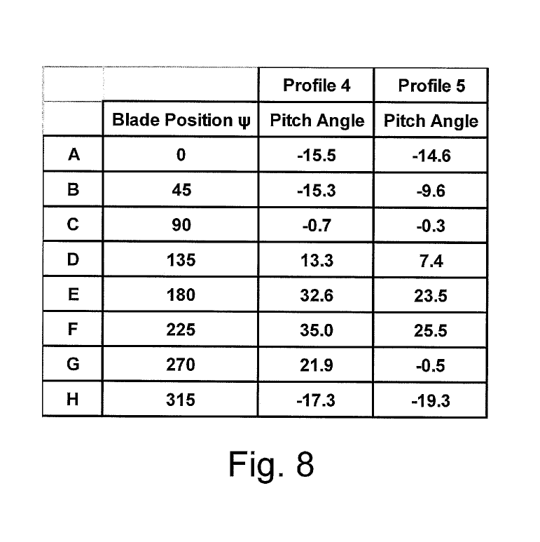

FIG. 8 is a table showing, for each of the two profiles shown in FIG. 7, the rotor blade pitch (theta) at the eight distinct blade positions A-H about the central axis of rotation of the turbine. Angular positions A-H set forth in FIG. 8 correspond to the angular positions shown in FIG. 2 about the axis of rotation of the rotor. Those of skill in the art will appreciate that the angles depicted in FIG. 8 are certain specific angles which have been shown to be useful within the context of the present disclosure. Those of skill in the art will also appreciate that similar profiles to those shown and described will be useful within the context of the present disclosure.

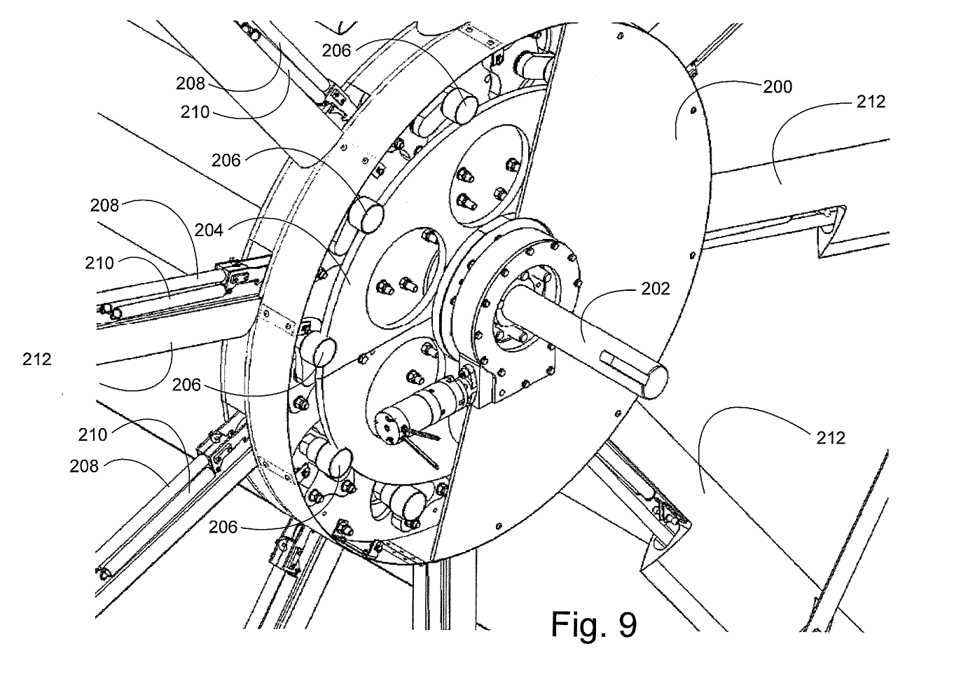

FIG. 9 is an isometric view of a rotor hub according to one embodiment of the present invention. Hub 200 revolves about stub axle 202 and cam 204 as the rotor revolves about its axis of rotation. Cam 204 remains stationary inside hub 200 as the rotor revolves. A set of rocker assemblies 206, secured to hub 200, ride on the outer surface of cam 204 as the hub 200 revolves. Each rocker assembly 206 is connected to an actuation rod 208 and at least one spring 210 secured to a strut at one end and the actuation rod 208 at the other. The springs 210 hold the cam followers securely against the outer surface of the cam 204.

Each actuation rod 208 is secured to a rocker assembly 206 at its proximal end and to a rotor blade at its distal end. Each actuation rod 208 controls the pitch of a particular rotor blade according to the position of a particular rocker assembly 206, which is, in turn, controlled by the profile of the outer surface of the cam 204 at the point of contact between the cam 204 and the cam follower of the rocker assembly 206. Thus, a rotor blade at a given radial location, will be articulated to a given pitch. As a rotor blade moves about the axis of rotation of the rotor, it will be articulated according to the pattern of the cam, which may be one of the patterns set forth heretofore, or may be a different pattern.

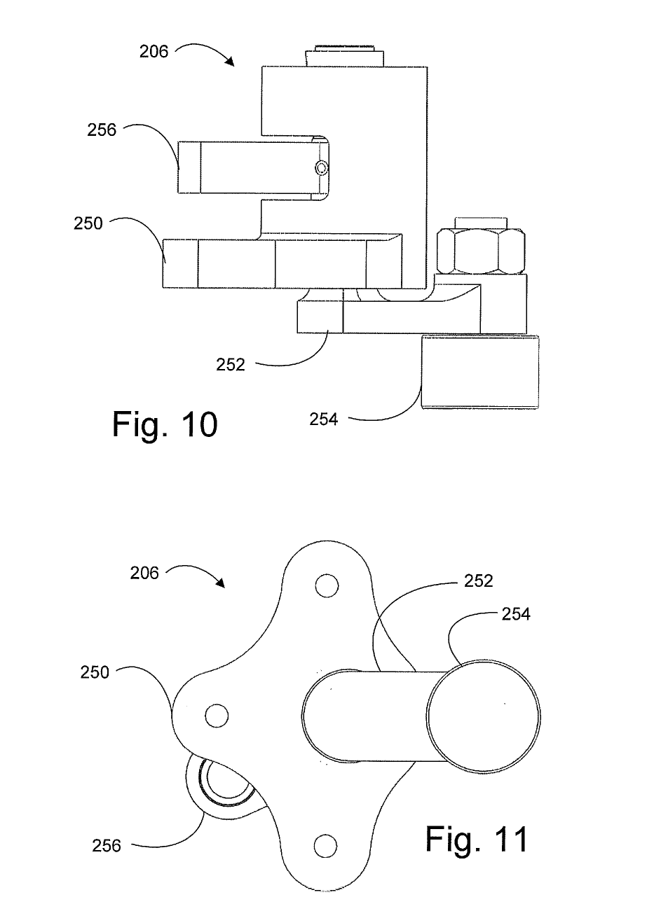

FIG. 10 is a front view of a rocker assembly according to certain embodiments of the present invention. FIG. 11 is a top view of a rocker assembly according to certain embodiments of the present invention. Rocker assembly 206 comprises a rocker cartridge 250 which acts as a frame for rocker assembly 206. Rocker cartridge 250 has a cylindrical body protruding from the back of a front flange, and a generally-cylindrical aperture passing from front to back. A rocker arm 252 is mounted to a shaft passing through the cylindrical aperture in the body of the rocker cartridge 250, and mounted in such a manner as to pivot about an axis of rotation passing through the aperture. In general, rocker arm 252 will pivot on bearings of some type, which may be sleeve bearings, ball bearings or needle bearings, as examples.

A cam follower bearing 254 is secured to the distal end of the rocker arm 252 and oriented in such manner as to freely rotate about an axis of rotation generally parallel to, but offset from, the axis of rotation of the rocker arm 252. Cam follower bearing 254 is designed to ride on the outer surface of cam 204 as hub 200 revolves around stub axle 202. Cam follower bearing 254 may be selected from any one of a number of bearing types, including sleeve bearings, ball bearings or needle bearings, as examples.

As cam follower bearing 254 rides along the outer surface of cam 204, rocker arm 252 will pivot to follow the profile of the outer surface of the cam 204, thereby rotating the shaft portion passing through the aperture in the body of the rocker cartridge 250. A lever arm 256 is secured to the shaft portion in such a manner as to pivot with the rocker arm 252. The lever arm 256 is also secured to an actuation rod 208 in such a manner as to move the actuation rod 208 as the rocker arm 252 rotates. With this arrangement, the actuation rod 208 moves according to the profile of the surface of cam 204 as the rocker assembly 206 moves about the cam 206.

It is believed that the operation and construction of the embodiments of the present patent application will be apparent from the Detailed Description set forth above. While the exemplary embodiments shown and described may have been characterized as being preferred, it should be readily understood that various changes and modifications could be made therein without departing from the scope of the present invention as set forth herein.

What is claimed is:

1. A fluid turbine comprising:
a rotor, having an axis of rotation, comprising at least two rotor blades disposed at a radius from the axis of rotation, each rotor blade having a pitch axis and a variable pitch angle; and
a mechanism operable to control the pitch angle of at least one rotor blade about its pitch axis and to vary the pitch angle of the rotor blade from a first pitch angle at a first radial location about the axis of rotation to a second pitch angle at a second radial location about the axis of rotation.

2. The fluid turbine of claim 1, wherein the first rotor blade pitch angle is between 10 degrees and 20 degrees to a plane orthogonal to a vector from the axis of rotation to the pitch axis of the rotor blade.

3. The fluid turbine of claim 1, wherein the first rotor blade pitch angle is parallel to a plane orthogonal to a vector from the axis of rotation to the pitch axis of the rotor blade.

4. The fluid turbine of claim 1, wherein the first rotor blade pitch angle is between 20 degrees and 30 degrees to a plane orthogonal to a vector from the axis of rotation to the pitch axis of the rotor blade.

5. The fluid turbine of claim 1, wherein the first rotor pitch angle is between 25 degrees and 35 degrees to a plane orthogonal to a vector from the axis of rotation to the pitch axis of the rotor blade.

6. The fluid turbine of claim 1, wherein the maximum rotor blade pitch angle for a rotor blade is imposed at a rotor position wherein that rotor blade is upstream of the axis of rotation of the rotor blade.

7. The fluid turbine of claim 1, wherein the minimum rotor blade pitch angle for a rotor blade is imposed at a rotor position wherein that rotor blade is downstream of the axis of rotation of the rotor blade.

8. A fluid turbine comprising:
a rotor, having an axis of rotation, comprising at least two rotor blades disposed at a radius from the axis of rotation, each rotor blade having a pitch axis and a variable pitch angle; and
a mechanism operable to control the pitch angle of at least one rotor blade about its pitch axis and to vary the pitch angle of the rotor blade from a first pitch angle at a first radial location about the axis of rotation to a second pitch angle at a second radial location about the axis of rotation to a third pitch angle at a third radial location about the axis of rotation.

9. The fluid turbine of claim 8, wherein the first rotor blade pitch angle is between 10 degrees and 20 degrees to a plane orthogonal to a vector from the axis of rotation to the pitch axis of the rotor blade.

10. The fluid turbine of claim 8, wherein the first rotor blade pitch angle is parallel to a plane orthogonal to a vector from the axis of rotation to the pitch axis of the rotor blade.

11. The fluid turbine of claim 8, wherein the first rotor blade pitch angle is between 20 degrees and 30 degrees to a plane orthogonal to a vector from the axis of rotation to the pitch axis of the rotor blade.

12. The fluid turbine of claim 8, wherein the first rotor pitch angle is between 25 degrees and 35 degrees to a plane orthogonal to a vector from the axis of rotation to the pitch axis of the rotor blade.

13. The fluid turbine of claim 8, wherein the maximum rotor blade pitch angle for a rotor blade is imposed at a rotor position wherein that rotor blade is upstream of the axis of rotation of the rotor blade.

14. The fluid turbine of claim 8, wherein the minimum rotor blade pitch angle for a rotor blade is imposed at a rotor position wherein that rotor blade is downstream of the axis of rotation of the rotor blade.

15. A fluid turbine comprising:
a rotor, having an axis of rotation, comprising at least two rotor blades disposed at a radius from the axis of rotation, each rotor blade having a pitch axis and a variable pitch angle; and
a mechanism operable to control the pitch angle of at least one rotor blade about its pitch axis and to vary the pitch angle of the rotor blade from a first pitch angle at a first radial location about the axis of rotation to a second pitch angle at a second radial location about the axis of rotation to a third pitch angle at a third radial location about the axis of rotation to a fourth pitch angle at a fourth radial location about the axis of rotation.

16. The fluid turbine of claim 15, wherein the first rotor blade pitch angle is parallel to a plane orthogonal to a vector from the axis of rotation to the pitch axis of the rotor blade.

17. The fluid turbine of claim 15, wherein the first rotor blade pitch angle is between 20 degrees and 30 degrees to a plane orthogonal to a vector from the axis of rotation to the pitch axis of the rotor blade.

18. The fluid turbine of claim 15, wherein the first rotor pitch angle is between 25 degrees and 35 degrees to a plane orthogonal to a vector from the axis of rotation to the pitch axis of the rotor blade.

19. The fluid turbine of claim 15, wherein the maximum rotor blade pitch angle for a rotor blade is imposed at a rotor position wherein that rotor blade is upstream of the axis of rotation of the rotor blade.

20. The fluid turbine of claim 15, wherein the minimum rotor blade pitch angle for a rotor blade is imposed at a rotor position wherein that rotor blade is downstream of the axis of rotation of the rotor blade.
